(19) United States
(12) Patent Application Publication
(10) Pub. No.: US 2026/0333203 A1
(43) Pub. Date: Oct. 22, 2026

(54) INDICATION AND DETECTION OF PHYSICAL BROADCAST CHANNEL TRANSMISSIONS

(71) Applicant: Lenovo (United States) Inc., Morrisville, NC (US)

(72) Inventors: Alexander Golitschek Edler von Elbwart, Darmstadt (DE); Prateek Basu Mallick, Dreieich (DE)

(73) Assignee: Lenovo (United States) Inc., Morrisville, NC (US)

(21) Appl. No.: 19/445,428

(22) Filed: Jan. 9, 2026

(51) Int. Cl. H04W 48/12

(52) U.S. Cl. CPC H04W 48/12

(57) ABSTRACT

Various aspects of the present disclosure relate to indication and detection of PBCH transmissions. An apparatus, such as a user equipment (UE), receives one or more sequences and one or more of a primary synchronization signal (PSS) or a secondary synchronization signal (SSS) in a slot. Based on detection of the one or more sequences in the slot, the UE detects a presence of a physical broadcast channel (PBCH) in the same slot. For example, the one or more sequences include one or more of a sequence number for the SSS or a sequence number for the PSS, which indicates the presence of the PBCH in the slot. Additionally, or alternatively, the one or more sequence numbers include a beacon sequence that indicates the presence of one or more of the SSS or the PBCH in the slot.

### TECHNICAL FIELD

The present disclosure relates to wireless communications, and more specifically to indication and detection of physical broadcast channel (PBCH) transmissions.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the device may be configured to, capable of, or operable to receive one or more sequences and one or more of a primary synchronization signal (PSS) or a secondary synchronization signal (SSS) in a slot; and detect a presence of a physical broadcast channel (PBCH) in the slot based on detection of the one or more sequences in the slot.

A processor (e.g., a standalone processor chipset, or a component of a device) for wireless communication is described. The processor may be configured to, capable of, or operable to perform one or more operations as described herein. For example, the processor may be configured to, capable of, or operable to receive one or more sequences and one or more of a PSS or an SSS in a slot; and detect a presence of a PBCH in the slot based on detection of the one or more sequences in the slot.

A method performed or performable by a UE for wireless communication is described. The method may include receiving one or more sequences and one or more of a PSS or an SSS in a slot; and detecting a presence of a PBCH in the slot based on detection of the one or more sequences in the slot.

In some implementations of the UE, the processor, and the method described herein, the UE, the processor, and the method may further be configured to, capable of, or operable to detect the one or more sequences in the slot, the one or more sequences including one or more of a sequence number for the PSS or a sequence number for the SSS. In some implementations of the UE, the processor, and the method described herein, one or more sequence numbers for the PSS or the SSS correspond to a respective offset, each offset indicated as a quantity of slots or a quantity of synchronization signal block (SSB)/PBCH block occurrences.

In some implementations of the UE, the processor, and the method described herein, one or more cell identifiers (IDs) corresponding to the one or more sequence numbers are unavailable for cell deployment based on the one or more sequence numbers indicating the presence of the PBCH in the slot.

In some implementations of the UE, the processor, and the method described herein, the sequence number for the SSS indicates a time offset between reception of one or more of the PSS or the SSS and reception of the PBCH. In some implementations of the UE, the processor, and the method described herein, the time offset indicates the PBCH is received in the slot, the PBCH is received immediately after the slot, or the PBCH is excluded from the slot.

In some implementations of the UE, the processor, and the method described herein, the UE, the processor, and the method may further be configured to, capable of, or operable to determine the time offset based on a subset of bits used to indicate the sequence number for the SSS. In some implementations of the UE, the processor, and the method described herein, the UE, the processor, and the method may further be configured to, capable of, or operable to detect the one or more sequences in the slot, the one or more sequences including a beacon sequence that indicates the presence of one or more of the SSS or the PBCH in the slot.

In some implementations of the UE, the processor, and the method described herein, the beacon sequence indicates a time offset between reception of the PSS and reception of one or more of the SSS or the PBCH. In some implementations of the UE, the processor, and the method described herein, the beacon sequence is separated from the PSS in the slot by a first quantity of guard subcarriers, the first quantity of guard subcarriers based on a second quantity of guard subcarriers between the SSS and the PBCH.

In some implementations of the UE, the processor, and the method described herein, the UE, the processor, and the method may further be configured to, capable of, or operable to detect a first beacon signal indicating a first beacon sequence and a second beacon signal indicating a second beacon sequence in the slot. In some implementations of the UE, the processor, and the method described herein, the UE, the processor, and the method may further be configured to, capable of, or operable to detect the presence of one or more of the SSS or the PBCH in the slot based on the first beacon sequence and the second beacon sequence.

An NE for wireless communication is described. The NE may be configured to, capable of, or operable to perform one or more operations as described herein. For example, the device may be configured to, capable of, or operable to transmit one or more sequences and one or more of a PSS or an SSS in a slot, where the one or more sequences indicate a presence of a PBCH in the slot; and transmit the PBCH in the slot based on the one or more sequences indicating the presence of the PBCH.

A processor (e.g., a standalone processor chipset, or a component of a device) for wireless communication is described. The processor may be configured to, capable of, or operable to perform one or more operations as described herein. For example, the processor may be configured to, capable of, or operable to transmit one or more sequences and one or more of a PSS or an SSS in a slot, where the one or more sequences indicate a presence of a PBCH in the slot; and transmit the PBCH in the slot based on the one or more sequences indicating the presence of the PBCH.

A method performed or performable by a NE for wireless communication is described. The method may include transmitting one or more sequences and one or more of a PSS or an SSS in a slot, where the one or more sequences indicate a presence of a PBCH in the slot; and transmitting the PBCH in the slot based on the one or more sequences indicating the presence of the PBCH.

In some implementations of the NE, the processor, and the method described herein, the NE, the processor, and the method may further be configured to, capable of, or operable to transmit the one or more sequences in the slot, the one or more sequences including one or more of a sequence number for the PSS or a sequence number for the SSS. In some implementations of the NE, the processor, and the method described herein, one or more sequence numbers for the PSS or the SSS correspond to a respective offset, each offset indicated as a quantity of slots or a quantity of SSB/PBCH block occurrences.

In some implementations of the NE, the processor, and the method described herein, one or more cell IDs corresponding to the one or more sequence numbers are unavailable for cell deployment based on the one or more sequence numbers indicating the presence of the PBCH in the slot. In some implementations of the NE, the processor, and the method described herein, the sequence number for the SSS indicates a time offset between transmission of one or more of the PSS or the SSS and transmission of the PBCH.

In some implementations of the NE, the processor, and the method described herein, the NE, the processor, and the method may further be configured to, capable of, or operable to transmit the one or more sequences in the slot, the one or more sequences including a beacon sequence that indicates the presence of one or more of the SSS or the PBCH in the slot.

### BRIEF DESCRIPTION OF THE DRAWINGS

FIG. 1 illustrates an example of a wireless communications system in accordance with aspects of the present disclosure.

FIG. 2 illustrates an example of synchronization signal transmissions as in accordance with aspects of the present disclosure.

FIG. 3 illustrates an example of a resource configuration in accordance with aspects of the present disclosure.

FIGS. 4 and 5 illustrate examples of PSS and SSS indications in accordance with aspects of the present disclosure.

FIGS. 6 through 8 illustrate examples of PBCH indications in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates a flowchart of a method performed by a UE in accordance with aspects of the present disclosure.

FIG. 13 illustrates a flowchart of a method performed by an NE in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. The devices can leverage synchronization signals to access a mobile network, which includes the detection of PSSs and SSSs and the decoding of PBCHs. A PSS may be used for initial synchronization of a UE to the NE to help the UE identify a cell and associated timing. Different PSS sequences may correspond to different cell IDs or cell ID groups. An NE may transmit an SSS after a PSS to provide additional information regarding the frequency of the cell and the cell ID (e.g., within a cell group). Together, the PSS and the SSS may enable a UE to establish time and frequency synchronization with the NE. A PBCH may be used to broadcast system information to one or more UEs in a cell. The PBCH may carry information such as scheduling information, system bandwidth, and other configuration parameters associated with initial access to the network.

As part of 5G Network Energy Saving (NES), a wireless communication system may support mechanisms to allow a network to reduce the transmission of broadcast control channels, such as synchronization signal block (SSB), system information block type 1 (SIB1), system information block type x (SIBx), and the like. By deviating from a periodic transmission pattern, potentially transmitting the information only when desired or necessary (e.g., on demand), the network may reduce its transmissions and save transmission power at least for those transmissions, and may potentially even shut down additional circuitry to save additional power.

In 6G systems, certain signaling aspects may be re-designed that would otherwise result in a non-backward compatible system (e.g., in 5G), which may lead to excessive UE power consumption. Consequently, the network may be afforded to transmit even basic signals and channels such as PSS, SSS, and PBCH with larger periodicity or on-demand basis.

In accordance with the described techniques, energy may be saved for basic cell signals and channels, such as those carried or facilitated by PSS, SSS, and PBCH. Specifically, the described techniques provide for indicating and detecting the presence or non-presence (e.g., lack of) SSS and PBCH by means of any combination of PSS, SSS, and sequence (i.e., beacon sequence) transmissions. A UE may receive a PSS in a slot. Based on the PSS, the UE may detect a presence of an SSS and a PBCH in the same slot. That is, the PSS may implicitly indicate to the UE that an NE is transmitting an SSS and a PBCH in the same slot. Alternatively, the UE may receive a PSS and an SSS in a slot, which together may indicate to the UE the presence of the PBCH in the same slot. In this way, the NE may embed information about the presence of a PBCH and an SSS in a PSS transmission or the presence of a PBCH in PSS and SSS transmissions.

In some examples, the NE may transmit a subset of a sequence of the PSS or sequences of the PSS and the SSS. For example, if the NE only transmits a subset of a sequence of the PSS, the UE may detect a lack of SSS and PBCH transmissions in the same slot. A subset of a PSS sequence or a subset of PSS and SSS sequences may also encode (and indicate to the UE) timing information until the next SSS and PBCH transmissions or the next PBCH transmission, respectively. In some implementations, after receiving a PSS, the UE may skip an indicated time gap and wait until an SSS and PBCH or PBCH transmission is included in the same slot according to an earlier PSS or PSS and SSS detection, respectively. Additionally, or alternatively, the NE may utilize a power boost when transmitting a subset of a PSS sequence to facilitate a reference signal received power (RSRP) based on the PSS subset. That is, the NE may transmit the subset of the PSS with the same transmit power the NE would use to transmit the full PSS sequence.

In some examples, the presence or non-presence of a PBCH in a slot may be indicated by one or more of a sequence number for a PSS, a sequence number for an SSS, or a beacon sequence. In such cases, the UE may receive one or more sequences and one or more of a PSS or an SSS in the slot. For example, if the UE receives a PSS and an SSS, the one or more sequences may include a sequence number (e.g., a first sequence number) for the PSS and a sequence number (e.g., a first sequence number) for the SSS. The UE may detect the presence of the PBCH in the slot based on detection of the one or more sequences, such as the sequence numbers for the PSS and the SSS, and consequently proceed with the processing of the PBCH. Alternatively, the one or more sequence numbers may include a beacon sequence. In such cases, the UE may detect the presence of one or more of the SSS or the PBCH in the slot based on the beacon sequence and consequently proceed with the processing of the SSS or the PBCH.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth. Aspects of the present disclosure are described in the context of a wireless communications system.

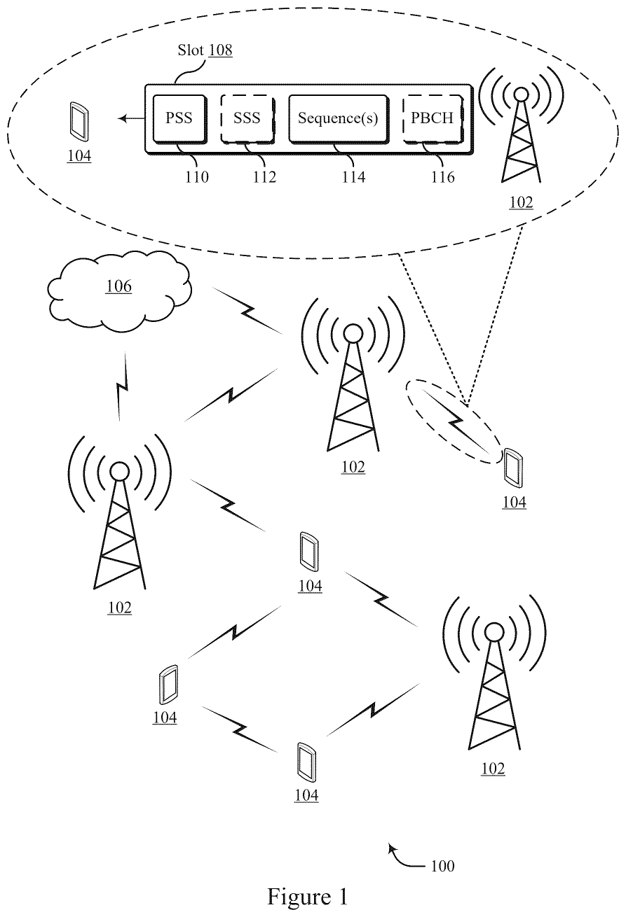

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplex (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHz), FR4a or FR4-1 (52.6 GHZ-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 detecting the presence or non-presence (e.g., lack of) an SSS 112 and a PBCH 116 in a slot 108 by means of PSS or PSS and SSS transmissions. The UE 104 may receive a PSS 110 in a slot 108 from an NE 102. Based on the PSS 110, the UE 104 may detect a presence of the SSS 112 and the PBCH 116 in the same slot, and consequently proceed with the processing of the PBCH 116. That is, the PSS 110 may implicitly indicate to the UE 104 that the NE 102 is transmitting an SSS 112 and a PBCH 116 in the same slot 108. Alternatively, the UE 104 may receive a PSS 110 and an SSS 112 in a slot 108, which together may indicate to the UE 104 the presence of the PBCH 116 in the slot 108. In such cases, the UE 104 may consequently proceed with the processing of the PBCH 116. In some examples, the NE 102 may transmit only a subset of a sequence of the PSS 110 or sequences of the PSS 110 and the SSS 112. For example, if the NE 102 only transmits a subset of a sequence of the PSS 110, the UE 104 may detect a lack of SSS and PBCH transmissions in the same slot 108.

In some examples, the presence or non-presence of a PBCH 116 in a slot 108 may be indicated by one or more sequences 114 such as a sequence number for a PSS, a sequence number for an SSS, or a beacon sequence. In such cases, the UE 104 may receive one or more sequences 114 and one or more of a PSS 110 or an SSS 112 in the slot. For example, if the UE 104 receives a PSS 110 and an SSS 112, the one or more sequences 114 may include a sequence number (e.g., a first sequence number) for the PSS 110 and a sequence number (e.g., a first sequence number) for the SSS 112. The UE 104 may detect the presence of the PBCH 116 in the slot 108 based on detection of the one or more sequences 114, such as the sequence numbers for the PSS 110 and the SSS 112. Alternatively, the one or more sequences 114 may include a beacon sequence, which may indicate a presence of one or more of the SSS 112 or the PBCH 116 in the slot.

It is understood that the described techniques are not limited to a single embodiment and/or implementation elements individually, and one or more elements from one or more implementations and/or embodiments may be combined to construct a new embodiment. Moreover, applicability and utilization of any of the proposed method, message exchange, architecture, configuration, measurement, capability information elements in the described techniques are not intended to be restricted to the particularly defined scenario and are intended to be interpreted as applicable for any alternate application/scenario, e.g., not being limited to a sensing measurement scenario and/or a positioning measurement scenario. As such, the sensing Tx nodes and the sensing Rx nodes may be a target UE device participating in a positioning task, that is participating in a measurement to obtain position information of the UE. A sensing target may be a target UE device for which a positioning information is derived or obtained by the network, or an object attached to, co-located with, or encompassing the UE.

Reference is made herein to communicating data or information, such as signaling that is transmitted or received between devices. It is to be appreciated that other terms may be used interchangeably with signaling, such as communicating, transmitting, receiving, outputting, forwarding, retrieving, obtaining, and so forth.

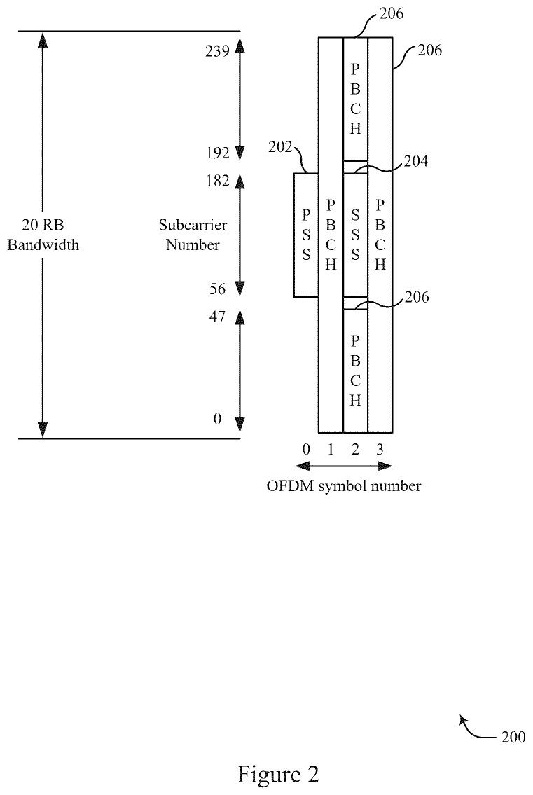

FIG. 2 illustrates an example of synchronization signal transmissions 200 as related to indication and detection of PBCH transmissions, in accordance with aspects of the present disclosure. The example synchronization signal transmissions 200 specifically depict PSS, SSS, and PBCH transmissions in 5G NR.

In a conventional LTE system, the detection of PSS and SSS transmissions not only enables time and frequency synchronization, but also provides a UE with a physical layer identity of a cell and a cyclic prefix length. The PSS and SSS transmissions also inform the UE of whether the cell uses frequency division duplex (FDD) or time division duplex (TDD).

In the case of initial synchronization (i.e., when the UE is not already camping on or connected to an LTE cell) after detection of the synchronization signals (e.g., the PSS and the SSS), the UE may decode a PBCH, from which the UE may obtain critical system information. In the case of neighbor cell identification, the UE may refrain from decoding the PBCH, and instead may make quality-level measurements based on reference signals transmitted from the newly-detected cell and uses them for cell reselection (e.g., in an RRC_IDLE state) or handover (e.g., in an RRC_CONNECTED state). In such cases, the UE may report these measurements to the UE's serving cell.

For an LTE system, the PSS and the SSS may be transmitted periodically, twice per 10 ms radio frame, for example. In an FDD cell, the PSS may be located in a last OFDM symbol of the first and eleventh slots of each radio frame, thus enabling the UE to acquire slot boundary timing independently from a cyclic prefix length. The SSS may be located in the symbol immediately preceding the PSS, a design choice that may enable coherent detection of the SSS relative to the PSS, based on the assumption that the channel coherence duration is significantly longer than one OFDM symbol. In a TDD cell, the PSS may be located in a third symbol of the third and thirteenth slots, while the SSS may be located three symbols earlier. In such cases, coherent detection may be used under the assumption that the channel coherence time may be significantly longer than four OFDM symbols. While the PSS in a given cell may be the same in every subframe in which the PSS is transmitted, the two SSS transmissions in each radio frame may change in a specific manner, thus enabling the UE to establish the position of the 10 ms radio frame boundary.

In the frequency domain, an NE may communicate (e.g., transmit, output, send) the PSS and the SSS within six central resource blocks (RBs), enabling the frequency mapping of the synchronization signals to be invariant with respect to the system bandwidth (which may, in principle, vary from 6 to 110 RBs to suit channel bandwidths between approximately 1.4 MHz and 20 MHz). This may allow the UE to synchronize to the network without any a priori knowledge of the allocated bandwidth. The PSS and the SSS each have a sequence length of 62 symbols, mapped to the central 62 carriers around a dual connectivity (DC) subcarrier, which is left unused. This means that the five resource elements at each extremity of each synchronization sequence are not used. Such a structure may enable the UE to detect the PSS and the SSS using a size-64 Fast Fourier Transform (FFT) and a lower sampling rate than would have been necessary if all 72 subcarriers were used in the central 6 RBs. The shorter length for the synchronization sequences also avoids the possibility in a TDD system of a high correlation with the uplink demodulation reference signals which use the same kind of sequence as the PSS.

The particular sequences which are transmitted for the PSS and the SSS in a given cell are used to indicate the physical layer cell identity to the UE. There may be 504 unique physical cell IDs (PCIs) in LTE, grouped into 168 groups of three IDs each. The three IDs in a group may usually be assigned to cells under the control of the same eNodeB. In this way, three PSS sequences may be used to indicate the cell ID within the group, and 168 SSS sequences may be used to indicate the ID of the group.

As described in the example synchronization signal transmissions 200, an NE may communicate (e.g., transmit, output, send) a PSS 202 and an SSS 204 in SSBs together with a PBCH 206. The blocks may be transmitted per slot at a fixed slot location. During an initial cell search, the UE may correlate the received signals and the synchronization signal sequences by means of matched filtering and attempt to locate the PSS 202 in order to obtain symbol and half-frame timing. The UE may then attempt to find the SSS 204 in order to detect the cyclic prefix length as well as the duplexing scheme and obtain the exact frame timing based on matched filter results for the PSS 202 and the SSS 204. Then, the UE may proceed with detecting the cell ID from the reference signals sequence index and decoding the PBCH 206 for the purpose of obtaining minimum system information.

In 5G NR, there may be 1008 unique physical-layer cell IDs, that is, an increased number compared to the 504 in LTE in order to provide sufficient deployment flexibility in dense network topologies. The NR physical-layer cell identities are in 336 unique physical-layer cell-ID groups, each group containing three unique IDs. Each NR cell ID may be jointly represented by a PSS/SSS combination. The PSS 202 may have three frequency-domain binary phase-shift keying (BPSK) length-127 M-sequences, and the SSS 204 may correspond to 336 gold sequences with length-127. Both of these signals are mapped into 127 contiguous subcarriers. A physical-layer cell ID is uniquely defined by a number in the range of 0 to 335, representing the physical-layer cell-ID group, and a number in the range of 0 to 2, representing a physical-layer identity within the physical-layer cell-ID group as in the following formula:

$${N}_{ID}^{cell} = 3 {N}_{ID}^{( 1 )} + {N}_{ID}^{( 2 )} ,$$

$$where$$

$$3 {N}_{ID}^{( 1 )} ∈ \{ 0 , 1 , … , 335 \}$$

$$and$$

$${N}_{ID}^{( 2 )} ∈ \{ 0 , 1 , 2 \} .$$

The PSS 202 may carry the cell number information, where the SSS 204 may carry the cell group number.

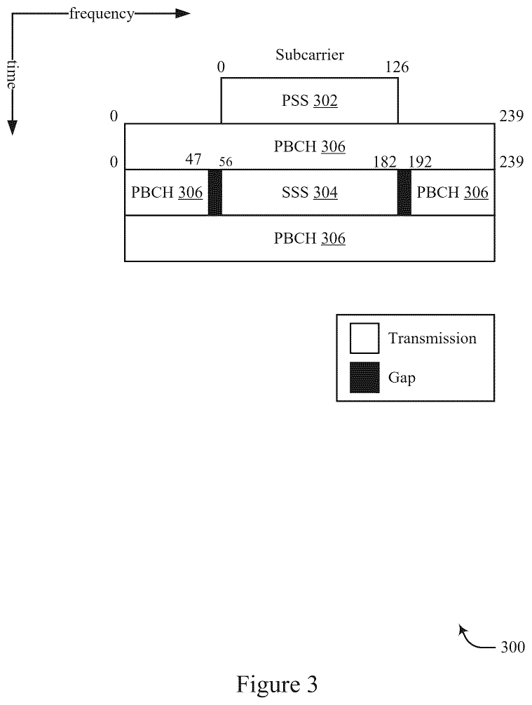

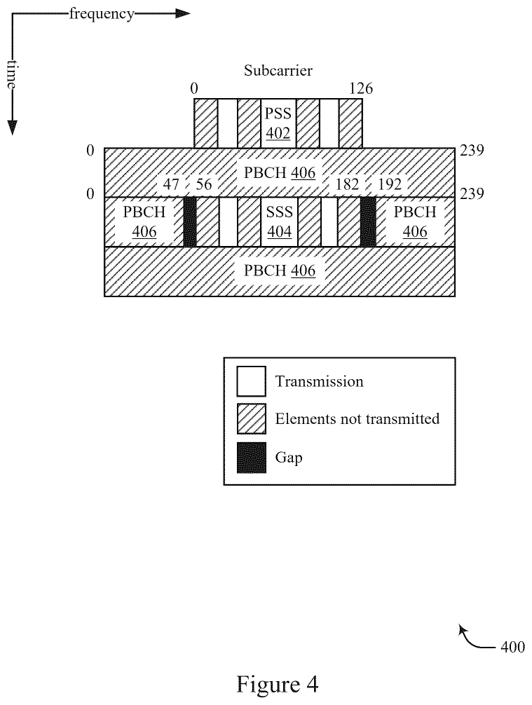

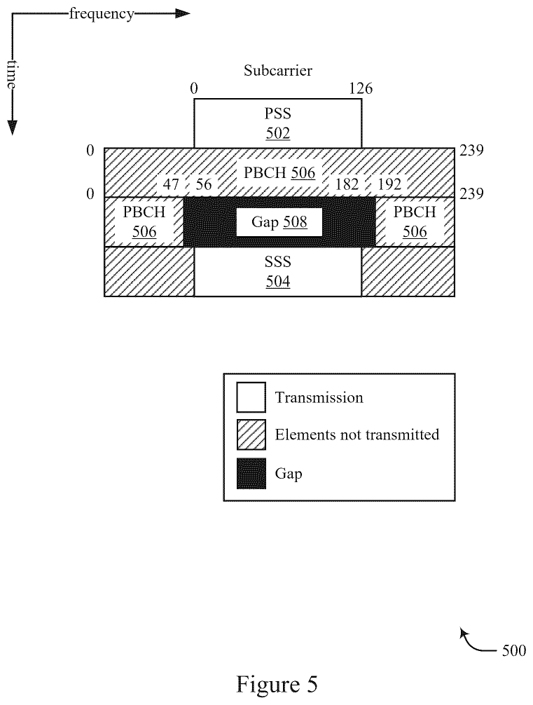

FIG. 3 illustrates an example of a resource configuration 300 for sensing scenarios as related to indication and detection of PBCH transmissions, in accordance with aspects of the present disclosure. The resource configuration generally depicts transmissions of a PSS 302, an SSS 304, and a PBCH 306 within a slot. The PSS 302 and the SSS 304 may each have a subcarrier length of 127 (spanning from subcarriers 0 to 126 and 56 to 182, respectively), and the PBCH 306 may have a subcarrier length of 240 (spanning from subcarriers 0 to 239). Generally, transmission of the PSS 302 or the PSS 302 and the SSS 304 may indicate whether the same slot includes the SSS 304 and the PBCH 306 (in the case of transmission of the PSS 302 only) or the PBCH 306 (in the case of transmission of the PSS 302 and the SSS 304, as described with reference to FIGS. 4 and 5). The resource configuration 300 may include gaps between transmissions, for example between subcarriers 48 through 55 and 183 through 191 between the PBCH 306 and the SSS 304. Such gaps are beneficial to limit the inter-carrier interference, for example, between SSS 304 and PBCH 306 in the same slot. The resource configuration 300 may include different PSS, SSS, and PBCH transmissions in 5G and 6G wireless communication systems.

In some implementations, transmission of the PSS 302 may indicate the presence (and consequently by inversion, the non-presence or lack) of an SSS 304 and a PBCH 306 transmitted in the same slot. An NE may communicate (e.g., transmit, output, send) a full PSS sequence in the slot, which may indicate that the same slot also includes SSS and PBCH transmissions. Alternatively, the NE may transmit only a subset of the PSS sequence in the slot, which may indicate that the NE only transmitted the PSS 302 in the slot but not the SSS 304 or the PBCH 306. That is, the UE may receive only a subset of the PSS 302 in the slot, such that the UE may detect a lack of the SSS 304 and the PBCH 306 in the slot based on the received subset of the PSS 302. Put another way, the NE may transmit a first subset of the PSS 402 and refrain from transmitting a second subset of the PSS 402, where the UE may detect the lack of the SSS 304 and the PBCH 306 based on receiving the first subset and not receiving the second subset.

In some implementations, the subset of the PSS sequence may include a number of non-zero elements that is a subset based on a fraction of the full PSS sequence length. Put another way, the subset of the PSS sequence may include at least one non-zero sequence element that corresponds to a fraction of the total sequence length of the PSS 302. By way of example, assuming that the full sequence of the PSS 302 has a length of 127, a first subset of the sequence may include only 63 non-zero elements, while a second (complimentary) subset may include only 64 non-zero elements. In case the NE does not transmit the SSS 304 or the PBCH 306 in the same slot, the NE may transmit only the first or second subset of the sequence of the PSS 302. The NE may construct the subsets such that a non-zero sequence element at a position number n (e.g., in the frequency domain, the subcarrier number n) of a subset may be the same sequence element at the same position number n (e.g., subcarrier n) of the full sequence. For example, a non-zero sequence element of the first subset of the sequence may correspond to a position of a subcarrier in the frequency domain that is the same as a position in the total sequence of the PSS 302.

In some examples, such PSS sequence subsets may be realized by placing elements (e.g., sequence elements) with odd-numbered position numbers (e.g., subcarrier numbers) at a same position in a subset and placing zeros at the even-numbered position numbers (e.g., subcarrier numbers) of the subset, or vice versa. The resource configuration 300 may support other subsets of non-zero elements in different formats. For example, the NE may transmit a subset of non-zero elements that are interleaved with other (e.g., zero-valued) elements, an upper half or a lower half of the non-zero elements (e.g., based on their position numbers), or any other alternatives. Transmitting a subset may still be sufficient for a UE to do a correlation of the subset of the PSS sequence (e.g., a partial PSS) and determine which PSS sequence is transmitted, and to establish basic timing. For example, the UE may determine a timing for receiving subsequent transmission based on receiving the first subset of the PSS sequence only. The determination of whether and which subset is received may be facilitated by correlating the received sequence with a subset of the reference sequence or the full set of the reference sequence, the reference sequence being the sequence that the UE would expect for the PSS 302, as may be the case.

In some implementation, the NE may transmit a subset of the PSS sequence with the same total power as the NE would transmit a full PSS transmission. This may allow the UE to perform a basic estimation and ranking of PSS transmissions of different cells regardless of whether the PSS transmissions include the full sequence or a partial sequence of the PSS 302. For example, since only non-zero elements contribute to the transmission power, the power for each of the non-zero elements, e.g., each of the 63 non-zero elements of a full sequence length of 127, may be boosted by a factor of 127 divided by 63 to arrive at the same overall transmit power.

In some examples, the subset of the PSS sequence may indicate how many more PSS occasions (or more generally, how many time units) may pass until the NE transmits the PSS 302, the SSS 304, and the PBCH 306 in the same slot. For example, a full PSS transmission (e.g., the PSS 302) may indicate that the NE is transmitting the SSS 304 and the PBCH 306 in the same slot. A transmission of the first subset of the PSS sequence may indicate that the next SSS and PBCH transmissions may occur a first number of transmission occasions after the first subset is transmitted (e.g., one half-frame or one frame later). A transmission of the second subset of the PSS sequence may indicate that the next SSS and PBCH transmissions may occur a second number of transmission occasions after the second subset is transmitted (e.g., two half-frames or two frames later). In this way, the UE may immediately detect the next PBCH transmission time without detecting additional PSS transmissions in the meantime.

Additionally, or alternatively, the indication associated with the PSS 302 transmission in a first occasion may also imply that the NE is to transmit the SSS 304 and the PBCH 306 a given time period after the PSS 302, or later. For example, a third subset of the PSS sequence may indicate that the NE is to transmit the SSS 304 and the PBCH 306 at earliest, some number of transmission occasions after transmission of the third subset (e.g., at the earliest, four half-frames or four frames later). Then, the UE may check for a PSS transmission in a second occasion according to some number of transmission occasions later than the first occasion to determine if and when the NE may include the SSS and PBCH transmissions in the same slot. For example, the PSS transmission in the second occasion may indicate that the NE is including the SSS 304 and the PBCH 306 in the same slot, or at a later time, according to other techniques described herein. This allows the UE to forego PSS/SSS detection efforts in transmission occasions between the first and second occasions, facilitating processing power saving for the UE.

FIG. 4 illustrates an example of PSS and SSS indications 400 as related to indication and detection of PBCH transmissions, in accordance with aspects of the present disclosure. The PSS and SSS indications 400 generally depict the transmission of a PSS 402 and an SSS 404 within a slot. The PSS 402 and the SSS 404 may each have a subcarrier length of 127 (spanning from subcarriers 0 to 126 and 56 to 182, respectively). The PSS and SSS indications 400 may include gaps between transmissions, for example between subcarriers 48 through 55 and 183 through 191. In the example of FIG. 4, transmission of the PSS 402 and the SSS 404 may indicate whether the same slot includes the PBCH 406.

In some implementations, transmission of the PSS 402 and the SSS 404 may indicate the presence (and consequently by inversion, the non-presence or lack) of a PBCH 406 transmitted in the same slot. An NE may communicate (e.g., transmit, output, send) a full PSS sequence and a full SSS sequence in the slot, which may indicate that the same slot also includes the PBCH transmission. Alternatively, the NE may transmit only a subset of the PSS sequence and only a subset of the SSS sequence in the slot, which may indicate that the NE only transmitted the PSS 402 and the SSS 404 in the slot but not the PBCH 406. That is, the UE may receive only a subset of the PSS 402 and only a subset of the SSS 404 in the slot, such that the UE may detect a lack of the PBCH 406 in the slot based on the received subset of the PSS 402 and the received subset of the SSS 404. Put another way, the NE may transmit a first subset of the PSS 402 and a first subset of the SSS 404, and refrain from transmitting a second subset of the PSS 402 and a second subset of the SSS 404. In this way, the UE may not receive both the first subset and the second subset at the same time, which may lead the UE to assume that the PBCH 406 is present instead of correctly assuming a lack of a PBCH 406.

In some implementations, the subset of the PSS sequence may include a number of non-zero elements that is a subset based on a fraction of the full PSS sequence length. Similarly, the subset of the SSS sequence may include a number of non-zero elements that is a subset based on a fraction of the full SSS sequence length. Put another way, the subset of the PSS sequence may include at least one non-zero sequence element that corresponds to a fraction of the total sequence length of the PSS 402, and the subset of the SSS sequence may include at least one non-zero sequence element that corresponds to a fraction of the total sequence length of the SSS 404. By way of example, assuming that the full sequence of the PSS 402 or the SSS 404 has a length of 127, a first subset of the sequence may include only 63 non-zero elements, while a second (complimentary) subset may include only 64 non-zero elements. In case the NE does not transmit the PBCH 406 in the same slot, the NE may transmit only the first or second subsets PSS and SSS sequences. The NE may construct the subsets such that a non-zero sequence element at a position number n (e.g., in the frequency domain, the subcarrier number n) of a subset may be the same sequence element at the same position number n (e.g., subcarrier n) of the full sequence. For example, a non-zero sequence element of the first subset of the sequence may correspond to a position of a subcarrier in the frequency domain that is the same as a position in the total sequence of the PSS 402 or the SSS 404.

In some examples, such PSS and SSS sequence subsets may be realized by placing elements (e.g., sequence elements) with odd-numbered position numbers (e.g., subcarrier numbers) at a same position in a subset and placing zeros at the even-numbered position numbers (e.g., subcarrier numbers) of the subset, or vice versa. The resource configuration of the PSS and SSS indications 400 may support other subsets of non-zero elements in different formats. For example, the NE may transmit a subset of non-zero elements that are interleaved with other (e.g., zero-valued) elements, an upper half or a lower half of the non-zero elements (e.g., based on their position numbers), or any other alternatives. The PSS and SSS indications 400 depicted in FIG. 4 indicate examples of which elements are not transmitted when the NE transmits only a subset of the PSS 402 and the SSS 404.

Transmitting a subset may still be sufficient for a UE to do a correlation of the subset of the PSS sequence (e.g., a partial PSS) and determine which PSS sequence is transmitted, and to establish basic timing. For example, the UE may determine a timing, such as a slot boundary, for receiving subsequent transmission based on receiving the first subset of the PSS sequence and the first subset of the SSS sequence only. Additionally, or alternatively, the transmitted subset of the PSS indicates a timing for transmission (by the NE) of at least one of a subsequent PSS, SSS, or PBCH. The determination of whether and which subset is received may be facilitated by correlating the received sequence with a subset of the reference sequence or the full set of the reference sequence, the reference sequence being the sequence that the UE would expect for the PSS 402 or SSS 404, as may be the case.

In some implementations, the NE may transmit a subset of the PSS sequence and a subset of the SSS sequence with the same total power as the NE would transmit a full PSS transmission and a full SSS transmission. This may allow the UE to perform a basic estimation and ranking of synchronization signal transmissions of different cells regardless of whether the synchronization signal transmissions include the full sequence or a partial sequence of the PSS 402 and the SSS 404. For example, since only non-zero elements contribute to the transmission power, the power for each of the non-zero elements, e.g., each of the 63 non-zero elements of a full sequence length of 127, may be boosted by a factor of 127 divided by 63 to arrive at the same overall transmit power. Additional details regarding the PSS and SSS indications 400 are described with reference to FIG. 5.

FIG. 5 illustrates an example of PSS and SSS indications 500 as related to indication and detection of PBCH transmissions, in accordance with aspects of the present disclosure. The PSS and SSS indications 500 generally depict the transmission of a PSS 502 and an SSS 504 within a slot, such as in the example of FIG. 4. The PSS 502 and the SSS 504 may each have a subcarrier length of 127 (spanning from subcarriers 0 to 126 and 56 to 182, respectively). In the example of FIG. 5, transmission of the PSS 502 and the SSS 504 may indicate whether the same slot includes a PBCH 506.

As described with reference to FIG. 4, the presence or non-presence of the PBCH 506 in the same slot at the PSS 502 and the SSS 504 may be indicated by symbols that carry the PSS 502 and the SSS 504. In reference to FIG. 5, the presence or non-presence of the PBCH 506 may also be indicated based on a gap 508 between the transmissions of the PSS 502 and the SSS 504 (e.g., in the time domain). For example, a gap 508 of one symbol between the PSS 502 and the SSS 504, for example where the PSS 502 being transmitted in symbol #2 and the SSS 504 being transmitted in symbol #4 of a slot (e.g., as in 5G NR for a subcarrier spacing of 15 kHz), may indicate that the NE is transmitting the PBCH 506 in the same slot (e.g., in symbols #3 through #5 as in 5G NR for a subcarrier spacing of 15 kHz). For a larger gap 508, for example where the PSS 502 is transmitted in symbol #2 and the SSS 504 is being transmitted in symbol #5 of the slot, may imply that the same slot does not include the PBCH 506 associated with the PSS 502 and the SSS 504. A UE would then refrain from attempting to detect a corresponding PBCH in such a slot.

In some implementations, the gap 508 between the PSS 502 and the SSS 504 may also indicate how many more PSS and SSS occasions (or more generally, how many time units) may pass until the NE transmits the PSS 502, the SSS 504, and the PBCH 506 in the same slot. For example, an SSS 504 transmitted two symbols after the PSS 502 may indicate that the NE is transmitting the PBCH 506 in the same slot. An SSS 504 being transmitted one symbol after the SSS 504 (e.g., the symbol immediately after the PSS 502) may indicate that the next and or SSS transmission is a first number of transmission occasions after the transmission of the SSS 504 (e.g., one half-frame or one frame later). An SSS 504 being transmitted three symbols after the PSS 502 may indicate that the next PSS and SSS transmission is a second number of transmission occasions after the transmission of the SSS 504 (e.g., two half-frames or two frames later). The UE may detect the presence or non-presence of the PBCH 506 or the PSS and SSS transmissions in a second occasion even if the NE fails to transmit the SSS 504 after the gap 508. That is, if the UE is unable to detect the SSS 504 in the expected location (e.g., after the gap 508 following the PSS 502), then the UE may determine that the NE is not transmitting the PBCH 506 in the same slot.

Additionally, or alternatively, further information may be indicated if the NE transmits the SSS 504 prior to the PSS 502. For example, an SSS 504 transmitted one symbol prior to the PSS 502 (e.g., the PSS 502 transmitted in the next symbol immediately after the SSS 504) may indicate that the next PSS and SSS transmission is a third number of transmission occasions after the transmission of the SSS 504 (e.g., three half-frames or three frames later). In this way, the UE may immediately detect the next PBCH transmission time, and may refrain from immediately detecting the next PBCH transmission time or additional PSS and SSS transmissions in the meantime.

Additionally, or alternatively, an indication from the PSS and SSS transmissions in a first occasion may imply that the NE is transmitting the PBCH 506 a given time period after the PSS and SSS transmissions, or later. For example, an SSS 504 transmitted three symbols after the PSS 502 may indicate that the NE is transmitting the PBCH 506 at earliest, a fourth number of transmission occasions after the transmission of the SSS 504 (e.g., four half-frames or four frames later). In such cases, the UE may check for PSS and SSS transmissions in a second occasion according to the fourth number of transmission occasions later than the first occasion to determine if and when a PBCH 506 is included in the same slot. For example, the PSS and SSS transmissions in the second occasion may indicate that the NE is including the PBCH 506 in the same slot, or at a later time, according to other features of the described techniques. This allows the UE to forego PSS/SSS detection efforts in transmission occasions between the first and second occasions, facilitating processing power saving for the UE.

In some implementations, the presence or non-presence of the PBCH 506 in the same slot as the PSS 502 and the SSS 504 may be indicated by a phase shift between the PSS and SSS transmissions, or by a phase shift applied to the SSS 504. For example, after detecting the PSS 502, the UE may employ the PSS 502 to detect the phase difference between the PSS 502 and the SSS 504. Assuming that both the PSS 502 and the SSS 504 employ BPSK, ignoring noise and interference, the phase difference between the PSS 502 and the SSS 504 may be 0 degrees. However, shifting the SSS transmission at the transmitter (e.g., NE) side instead of transmitting (+1 or −1) for the SSS BPSK symbols the shifted SSS BPSK symbols are at (+j or −j). A receiver (e.g., the UE) may correspondingly detect such a phase shifted sequence by doing a complex cross-correlation. For example, a shift of 0 degrees may indicate that the NE is transmitting the PBCH 506 in the same slot as the PSS 502 and the SSS 504. A non-zero shift (e.g., potentially greater than a threshold to establish some resilience against noise and interference) may imply that the same slot does not include a PBCH 506 associated with the PSS 502 and the SSS 504. A UE may refrain from attempting to detect a PBCH 506 in such a slot.

Additionally, or alternatively, the phase shift may indicate how many more PSS and SSS occasions (or more generally, how many time units) may pass until the NE transmits the PSS 502, the SSS 504, and the PBCH 506 in the same slot. For example, a phase shift of 90 degrees may indicate that the NE transmits the PBCH 506 in the same slot. A phase shift of 180 degrees may indicate that the next PSS and SSS transmission is a first number of transmission occasions after the transmission of the PSS 502 and the SSS 504 (e.g., one half-frame or one frame later). A phase shift of 270 degrees may indicate that the next PSS and SSS transmission is a second number of transmission occasions after the transmission of the PSS 502 and the SSS 504 (e.g., two half-frames or two frames later). In this way, the UE may immediately detect the next PBCH transmission time, and may refrain from detecting additional PSS and SSS transmissions in the meantime.

Additionally, or alternatively, the phase shift may also imply that the NE is transmitting the PBCH 506 a given time period after the NE transmits the PSS 502 and the SSS 504 in a first occasion, or later. For example, a phase shift of 180 degrees may indicate that the NE is transmitting the PBCH 506 at the earliest, a number of transmission occasions after transmission of the SSS 504 (e.g., four half-frames or frames later). The UE may use this information to check for PSS and SSS transmission in a second occasion at the number of transmission occasions (e.g., four half-frames or frames later), and the UE may then use the PSS and SSS transmissions in the second occasion to determine if and when the NE included the PBCH 506. For example, the PSS and SSS transmissions in the second occasion may indicate that the NE included the PBCH 506 in the same slot, or at a later time, according to other features of the described techniques. This allows the UE to forego PSS/SSS detection efforts in transmission occasions between the first and second occasions, facilitating processing power saving for the UE.

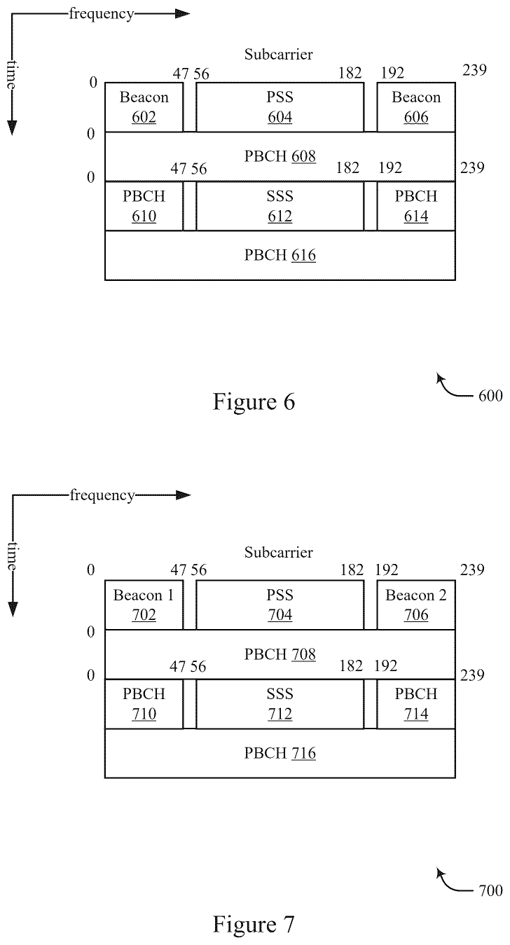

FIG. 6 illustrates an example of a PBCH indication 600 as related to indication and detection of PBCH transmissions, in accordance with aspects of the present disclosure. The PBCH indication 600 generally depicts the transmission of a PSS 604 and an SSS 612 within a slot, such as in the examples of FIGS. 4 and 5. The PSS 604 and the SSS 612 may each have a subcarrier length of 127 (each spanning from subcarriers 56 to 182). In addition, the PBCH indication 600 may include transmission of beacon sequences, such as a beacon 602 and a beacon 606.

In some implementations, the presence or non-presence of a PBCH in the slot (such as a PBCH 608, a PBCH 610, a PBCH 614, or a PBCH 616) may be indicated by one or more of a sequence number for a PSS or a sequence number for an SSS, where the sequence numbers are first sequence numbers corresponding to the respective signal. For example, an SSS sequence number 0 may imply (i.e., indicate) that there is no PBCH transmission included in the same slot, whereas other SSS sequence numbers may imply (i.e., indicate) that there is a PBCH transmission included in the same slot. The SSS sequence number may generally correspond to or depend on

$${N}_{ID}^{( 1 )} ∈ \{ 0 , 1 , … , 335 \} .$$

In some examples, as one or more SSS sequence numbers may be used to indicate an offset to a next PBCH transmission, the corresponding

$${N}_{ID}^{( 1 )}$$

values may not also be used to determine a cell ID according to

$${N}_{ID}^{cell} = 3 {N}_{ID}^{( 1 )} + {N}_{ID}^{( 2 )} .$$

As a result, when the SSS sequence number 0 is used to indicate the lack or non-presence of a PBCH transmission, for example, cell IDs 0, 1, and 2 may not be used in the deployment.

In some examples, the offset to the next PBCH transmission may be in a time domain unit such as a number of slots, a number of SSB or PBCH block occurrences, or any other predetermined time unit. For example, the indicated offset may correspond to a number of 20 ms intervals, where PSSs and SSSs are transmitted every 20 ms. The sequence number or cell ID may directly correspond to the offset. Generally, a first sequence number may be associated with a first offset value, a second sequence number may be associated with a second offset value, and so forth. As such, the correspondence (e.g., relationship, mapping) between sequence numbers and offset values may be defined by a lookup table, such as Table 1.

TABLE 1

| Sequence Number (ID) | Associated Offset | |
|---|---|---|
| 0 | 1 | slot |
| 1 | 20 | ms |
| 2 | 160 | ms |

In some implementations, the SSS sequence numbers may indicate an instance or offset to the next time a PBCH is transmitted after the detected PSS and/or the detected SSS, or later. For example, SSS sequence numbers

$${n}_{Offset}^{( 1 )} ∈ \{ 0 , 1 , … , {N}_{Offset , max}^{( 1 )} - 1 \}$$

may indicate that the PBCH is included in slot

$${n}_{Offset}^{( 1 )} + 1$$

after the detected PSS, SSS, or both. There may be a case in which at least one of the numbers, for example, a highest such number,

$${N}_{Offset , max}^{( 1 )} - 1 ,$$

is used to indicate that a PBCH is included in or after the corresponding indicated occasion. In such cases, a receiver (e.g., a UE) may check the SSS in the indicated slot and determine at that time, from the SSS and using the techniques described herein, whether the PBCH is included or excluded from (e.g., lacking from, not present in) the same slot. In some cases, the UE may use only some (i.e., a subset) of the bits or numbers of

$${n}_{Offset}^{( 1 )}$$

to determine an instance or offset to the next PBCH. For example, the UE may use the three least-significant bits (LSBs) of

$${n}_{Offset}^{( 1 )}$$

to determine the offset. In another example, the UE may use

$${n}_{Offset}^{( 1 )} mod 7$$

to determine the offset. IT should be noted that any pre-defined or configured quantity of bits or numbers of

$${n}_{Offset}^{( 1 )}$$

may be used to determine the offset.

A value of

$${N}_{Offset , m ax}^{( 1 )}$$

may be chosen such that a sufficient number of offsets may be represented without reducing the number of available cell IDs too significantly. As described herein, assuming that

$${N}_{ID}^{cell} = a \cdot {N}_{ID}^{( 1 )} + {N}_{ID}^{( 2 )} ,$$

any one potential sequence number associated with sequence number

$${N}_{ID}^{( 1 )}$$

invalidates

$$a \cdot {N}_{ID}^{( 1 )}$$

cell IDs from the IDs available for a cell deployment. Table 2 provides an example of a correspondence (e.g., association, mapping) between LSBs of a sequence number and an associated instance or offset to the next PBCH.

TABLE 2

| LSBs of Sequence Number (ID) | Associated Offset | |
|---|---|---|
| 00 | 1 | slot |
| 01 | 20 | ms |
| 10 | 160 | ms |
| 11 | 320 | ms |

In some examples, an SSS sequence number

$${n}_{Offset}^{( 1 )} ∈ \{ 0 , 1 , … , {N}_{Offset , m ax}^{( 1 )} - 1 \}$$

may indicate that a PBCH is not included in the same slot as the SSS and/or a PSS. Depending on the number

$${n}_{Offset}^{( 1 )} ∈ \{ 0 , 1 , … , {N}_{Offset , m ax}^{( 1 )} - 1 \} ,$$

a receiver (e.g., a UE) may ultimately determine that

$${n}_{Offset}^{( 1 )} = {N}_{ID}^{( 1 )} mod {N}_{Offset , ma x}^{( 1 )} ,$$

which results in inferring potential values of

$${N}_{ID}^{( 1 )}$$

based on known values of

$${N}_{Offset , ma x}^{( 1 )} and {n}_{Offset}^{( 1 )} .$$

This may narrow down the possible values of

$${N}_{ID}^{( 1 )}$$

considerably when detecting a cell ID from an SSS transmitted together in a slot with the PBCH. In some examples,

$${N}_{Offset , m ax}^{( 1 )}$$

may be chosen such that

$${N}_{offset , m ax}^{( 1 )}$$

is a divisor of the potential number of SSS sequence numbers. For example, if there are a total of 336 sequence numbers,

$${N}_{Offset , m ax}^{( 1 )}$$

may be chosen as

$${N}_{Offset , m ax}^{( 1 )} ∈ \{ 1 , 2 , 3 , 4 , 6 , 7 , 8 , 12 , 14 , 16 , 21 , 24 , 28 , 42 , 48 , 56 , 84 , 112 , 168 \} .$$

In some examples, instead of using one or both of the PSS 604 and the SSS 612 to indicate an instance or offset, an alternative sequence design such as a beacon sequence may be used to indicate the offset. In such cases, the beacon 602 and the beacon 606 may facilitate a shorter sequence than the PSS 604 or the SSS 612, which may allow for a more efficient use of the spectrum and reduced detection complexity. In some examples, the beacon sequence may be mapped to resources other than those used for the PSS 604 and the SSS 612 but in the same time slot as would be expected for any of the PSS, SSS, and PBCH transmissions described herein.

As described with reference to FIG. 6, the transmission of a specific beacon sequence (e.g., beacon sequence #0) may indicate that a PBCH is transmitted in the same slot. Otherwise, the UE may determine that no PBCH is transmitted in the same slot. In some cases, the indication of a lack of a transmission also extends to SSS transmission. For example, the transmitted beacon sequence may indicate (e.g., imply) whether both or neither of the SSS 612 and a PBCH (e.g., the PBCH 616) are transmitted.

Alternatively, the NE may refrain from transmitting a beacon sequence. In such cases, the lack of a beacon sequence transmission may indicate that a PBCH is transmitted in the same slot. Otherwise, the UE may determine that no PBCH is transmitted in the same slot. In some cases, the indication of a lack of a transmission also extends to SSS transmission. For example, the transmitted beacon sequence may indicate (e.g., imply) whether both or neither of the SSS 612 and a PBCH (e.g., the PBCH 616) are transmitted.

Alternatively, when the NE transmits a beacon sequence, a corresponding beacon sequence number may indicate an instance or offset to the next occurrence of a PBCH transmission or an SSS transmission and the PBCH transmission, similarly to the offset indication based on the SSS sequence ID, as described herein.

FIG. 7 illustrates an example of a PBCH indication 700 as related to indication and detection of PBCH transmissions, in accordance with aspects of the present disclosure. The PBCH indication 700 generally depicts the transmission of a PSS 704 and an SSS 712 within a slot, such as in the example of FIG. 6. The PSS 704 and the SSS 712 may each have a subcarrier length of 127 (spanning from subcarriers 56 to 182). In addition, the PBCH indication 700 may include transmission of beacon sequences, such as a beacon 1 702 (i.e., a first beacon) and a beacon 2 706 (i.e., a second beacon). The PBCH indication 700 may include PBCH transmissions as indicated by one or more sequences associated with the PSS 704, the SSS 712, the beacon 1 702, or the beacon 2 706. For example, the PBCH transmissions may include a PBCH 708, a PBCH 710, a PBCH 714, and a PBCH 716.

In some implementations, there may be a number of guard subcarriers between subcarriers carrying beacon sequences and any one or more of the PSS, SSS, or PBCH transmissions. Guard periods between PBCH subcarriers and SSS subcarriers may be eight or nine subcarriers wide (i.e., long), so it may be configured to have at least the lower of that number as the number of gap subcarriers between the beacon and PSS, SSS, or PBCH subcarriers, as applicable. For example, there may be a total of 48+49=97 available subcarriers (e.g., based on subcarriers 0 through 47 and 191 through 239) for the beacon sequence. In cases where a shorter sequence length may be desirable, for example, one suitable candidate may be an m-sequence of length 63. Such a sequence may then be split to occupy subcarriers 0 through 31 and 209 through 239 (or 0 through 30 and 208 through 239 depending on the configuration).

The combination of both beacon sequence IDs (of the beacon 1 702 and the beacon 2 706) may be used to determine whether and where SSS transmissions, PBCH transmissions, or both may occur. For example, if the beacon sequence IDs of the beacon 1 702 and the beacon 2 706 are zero, then the UE may determine that a PBCH or an SSS and a PBCH is transmitted in the same slot. Alternatively, if neither the beacon 1 702 or the beacon 2 706 are transmitted, the UE may determine at least that there is no PBCH transmitted in the same slot. In some examples, the instance or offset to the next PBCH transmission may be indicated by the summation of the beacon sequence IDs for the beacon 1 702 and the beacon 2 706. Alternatively, one of the beacon 1 702 and the beacon 2 706 may be associated with an instance or an offset to a next SSS transmission, while the other of the beacon 1 702 and the beacon 2 706 may be associated with the offset to the next PBCH transmission. For example, if the beacon 1 702 is associated with the offset to the next SSS transmission, the beacon 2 706 may be associated with the offset to the next PBCH transmission.

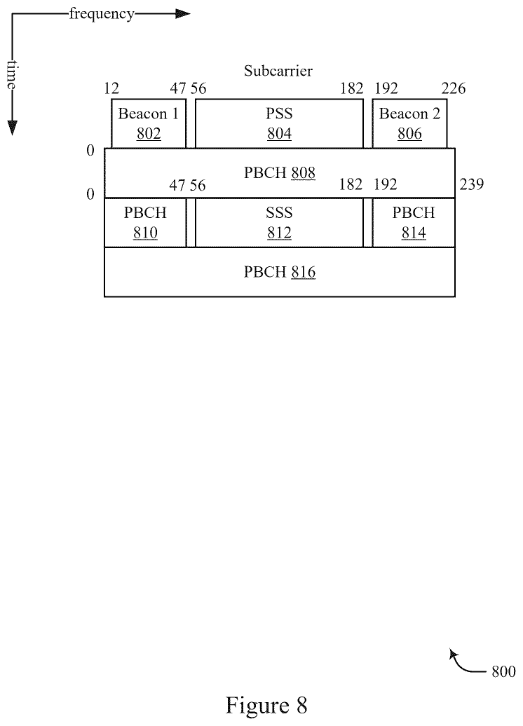

FIG. 8 illustrates an example of a PBCH indication 800 as related to indication and detection of PBCH transmissions, in accordance with aspects of the present disclosure. The PBCH indication 800 generally depicts the transmission of a PSS 804 and an SSS 812 within a slot, such as in the examples of FIGS. 6 and 7. The PSS 804 and the SSS 812 may each have a subcarrier length of 127 (spanning from subcarriers 56 to 182). In addition, the PBCH indication 800 may include transmission of beacon sequences, such as a beacon 1 802 and a beacon 2 806. The PBCH indication 800 may include PBCH transmissions as indicated by one or more sequences associated with the PSS 804, the SSS 812, the beacon 1 802 (i.e., a first beacon), or the beacon 2 806 (i.e., a second beacon). For example, the PBCH transmissions may include a PBCH 808, a PBCH 810, a PBCH 814, and a PBCH 816.

As described with reference to FIG. 7, there may be a number of guard subcarriers between subcarriers carrying beacon sequences and any one or more of the PSS, SSS, or PBCH transmissions. In the example of FIG. 8, particularly when a sequence length is smaller than 97, there may be guard subcarriers not only between the beacon and the PSS, SSS, and PBCH subcarriers, but also on the outside of the beacons. For example, a beacon sequence may be split to occupy subcarriers 16 through 47 and 192 through 222, or alternatively, split such that the effective gaps are almost even between outer edges (e.g., subcarriers 0 and 239) and inner signals (e.g., subcarriers 56 and 182). For example, if the beacon signals are mapped to subcarriers 12 through 43 and 196 through 226, then the gap between the lower edge and the beacon 1 802 includes of blank (e.g., empty) subcarriers 0 through 11, then a gap of blank subcarriers between the beacon 1 802 and the PSS 804 on subcarriers 44 through 55, then a gap of blank subcarriers between the PSS 804 and the beacon 2 806 on subcarriers 183 through 195, and a gap between the beacon 2 806 and the upper edge on subcarriers 227 through 239. In such examples, the gaps are 12, 12, 13, and 13 subcarriers wide or long, respectively.

In some implementations, the regions for the beacon sequence may be split to carry a first and a second beacon signal, as described with reference to FIGS. 7 and 8. Such configurations may allow for the transmission of two different beacon sequences of smaller maximum length. For example, if m-sequences are desired for their strong correlation properties, it may be beneficial to employ two m-sequences of length 31 each, transmitted in resources for the beacon 1 802 and the beacon 2 806, respectively. The NE may then transmit the beacon 1 802 using subcarriers 0 through 30 and the beacon 2 806 using subcarriers 209 through 239. Alternatively, to even out the subcarrier gaps between the lower, upper, and inner edges of the transmitted signals, the beacon 1 802 may be mapped to subcarriers 12 through 42 and the beacon 2 806 may be mapped to subcarriers 196 through 226. Such a configuration may create gaps on subcarriers 0 through 11, 43 through 55, 183 through 195, and 227 through 239 (i.e. with widths or lengths of 12, 13, 13, and 13 subcarriers, respectively).

The combination of both beacon sequence IDs (of the beacon 1 802 and the beacon 2 806) may be used to determine whether and where SSS transmissions, PBCH transmissions, or both may occur. For example, if the beacon sequence IDs of the beacon 1 802 and the beacon 2 806 are zero, then the UE may determine that a PBCH or an SSS and a PBCH is transmitted in the same slot. Alternatively, if neither the beacon 1 802 or the beacon 2 806 are transmitted, the UE may determine at least that there is no PBCH transmitted in the same slot. In some examples, the instance or offset to the next PBCH transmission may be indicated by the summation of the beacon sequence IDs for the beacon 1 802 and the beacon 2 806. Alternatively, one of the beacon 1 802 and the beacon 2 806 may be associated with an instance or an offset to a next SSS transmission, while the other of the beacon 1 802 and the beacon 2 806 may be associated with the offset to the next PBCH transmission. For example, if the beacon 1 802 is associated with the offset to the next SSS transmission, the beacon 2 806 may be associated with the offset to the next PBCH transmission.

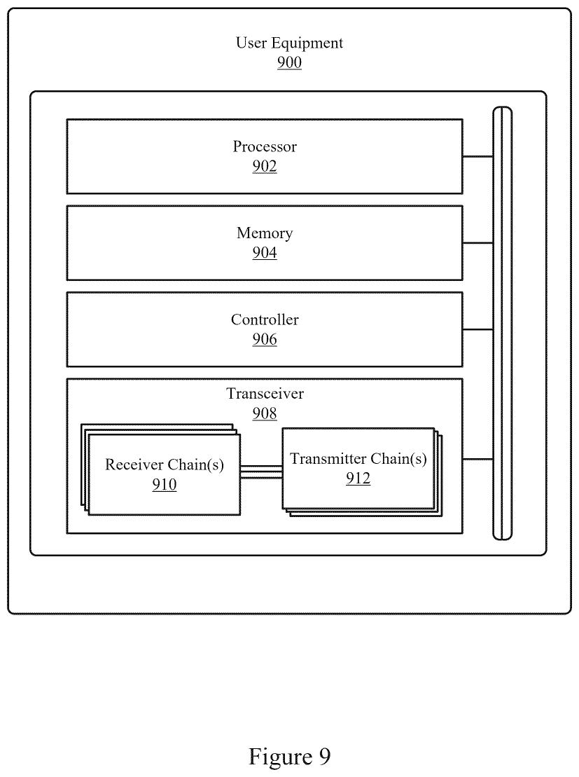

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving one or more sequences and one or more of a PSS or an SSS in a slot; and detecting a presence of a PBCH in the slot based on detection of the one or more sequences in the slot. In this manner, the UE 900 supports power and energy saving for various cell signals and channels by enabling the presence or non-presence of a PBCH to be indicated and detected by means of a PSS or a PSS and an SSS.

Additionally, the UE 900 may be configured to support any one or combination of the following. For example, the UE 900 may be configured to support detecting the one or more sequences in the slot, the one or more sequences including one or more of a sequence number for the PSS or a sequence number for the SSS. This aspect ensures power savings by enabling PSS and/or SSS sequences to indicate the presence of a PBCH. Additionally, or alternatively, the UE 900 may be configured to support where one or more sequence numbers for the PSS or the SSS correspond to a respective offset, each offset indicated as a quantity of slots or a quantity of SSB/PBCH block occurrences. This aspect improves efficiency of PBCH indication and detection by defining an instance or an offset to a next PBCH transmission.

Additionally, or alternatively, the UE 900 may be configured to support where one or more cell IDs corresponding to the one or more sequence numbers are unavailable for cell deployment based on the one or more sequence numbers indicating the presence of the PBCH in the slot. This aspect improves efficiency of PBCH indication and detection by defining a relationship between SSS IDs and the offset to the next PBCH transmission. Additionally, or alternatively, the UE 900 may be configured to support where the sequence number for the SSS indicates a time offset between reception of one or more of the PSS or the SSS and reception of the PBCH. This aspect improves efficiency of PBCH indication and detection by defining a relationship between SSS IDs and the offset to the next PBCH transmission.

Additionally, or alternatively, the UE 900 may be configured to support where the time offset indicates the PBCH is received in the slot, the PBCH is received immediately after the slot, or the PBCH is excluded from the slot. This aspect improves efficiency of PBCH indication and detection by defining an instance or an offset to a next PBCH transmission. Additionally, or alternatively, the UE 900 may be configured to support determining the time offset based on a subset of bits used to indicate the sequence number for the SSS. This aspect improves efficiency of PBCH indication and detection by defining an offset to a next PBCH transmission.

Additionally, or alternatively, the UE 900 may be configured to support detecting the one or more sequences in the slot, the one or more sequences including a beacon sequence that indicates the presence of one or more of the SSS or the PBCH in the slot. This aspect ensures power savings by enabling beacon sequences to indicate the presence of a PBCH. Additionally, or alternatively, the UE 900 may be configured to support where the beacon sequence indicates a time offset between reception of the PSS and reception of one or more of the SSS or the PBCH. This aspect ensures power savings by enabling the use of beacon signals to indicate SSS transmissions, PBCH transmissions, or both, or to indicate an offset to a next SSS transmission, a next PBCH transmission, or both.

Additionally, or alternatively, the UE 900 may be configured to support where the beacon sequence is separated from the PSS in the slot by a first quantity of guard subcarriers, the first quantity of guard subcarriers based on a second quantity of guard subcarriers between the SSS and the PBCH. This aspect ensures the efficient use of the spectrum and reduced detection complexity by enabling beacon sequences to indicate the presence of a PBCH. Additionally, or alternatively, the UE 900 may be configured to support detecting a first beacon signal indicating a first beacon sequence and a second beacon signal indicating a second beacon sequence in the slot. This aspect ensures the efficient use of the spectrum and reduced detection complexity by enabling beacon sequences to indicate the presence of a PBCH. Additionally, or alternatively, the UE 900 may be configured to support detecting the presence of one or more of the SSS or the PBCH in the slot based on the first beacon sequence and the second beacon sequence. This aspect ensures the efficient use of the spectrum and reduced detection complexity by enabling beacon sequences to indicate the presence of a PBCH.

Additionally, or alternatively, the UE 900 may support at least one memory (e.g., the memory 904) and at least one processor (e.g., the processor 902) coupled with the at least one memory and configured to cause the UE 900 to receive one or more sequences and one or more of a PSS or an SSS in a slot; and detect a presence of a PBCH in the slot based on detection of the one or more sequences in the slot. In this manner, the UE 900 supports power and energy saving for various cell signals and channels by enabling the presence or non-presence of a PBCH to be indicated and detected by means of a PSS or a PSS and an SSS.

Additionally, the UE 900 may be configured to support any one or combination of the following. For example, the UE 900 may be configured to support detecting the one or more sequences in the slot, the one or more sequences including one or more of a sequence number for the PSS or a sequence number for the SSS. This aspect ensures power savings by enabling PSS and/or SSS sequences to indicate the presence of a PBCH. Additionally, or alternatively, the UE 900 may be configured to support where one or more sequence numbers for the PSS or the SSS correspond to a respective offset, each offset indicated as a quantity of slots or a quantity of SSB/PBCH block occurrences. This aspect improves efficiency of PBCH indication and detection by defining an instance or an offset to a next PBCH transmission.

Additionally, or alternatively, the UE 900 may be configured to support where one or more cell IDs corresponding to the one or more sequence numbers are unavailable for cell deployment based on the one or more sequence numbers indicating the presence of the PBCH in the slot. This aspect improves efficiency of PBCH indication and detection by defining a relationship between SSS IDs and the offset to the next PBCH transmission. Additionally, or alternatively, the UE 900 may be configured to support where the sequence number for the SSS indicates a time offset between reception of one or more of the PSS or the SSS and reception of the PBCH. This aspect improves efficiency of PBCH indication and detection by defining a relationship between SSS IDs and the offset to the next PBCH transmission.

Additionally, or alternatively, the UE 900 may be configured to support where the time offset indicates the PBCH is received in the slot, the PBCH is received immediately after the slot, or the PBCH is excluded from the slot. This aspect improves efficiency of PBCH indication and detection by defining an offset to a next PBCH transmission. Additionally, or alternatively, the UE 900 may be configured to support determining the time offset based on a subset of bits used to indicate the sequence number for the SSS. This aspect improves efficiency of PBCH indication and detection by defining an offset to a next PBCH transmission.

Additionally, or alternatively, the UE 900 may be configured to support detecting the one or more sequences in the slot, the one or more sequences including a beacon sequence that indicates the presence of one or more of the SSS or the PBCH in the slot. This aspect ensures power savings by enabling beacon sequences to indicate the presence of a PBCH. Additionally, or alternatively, the UE 900 may be configured to support where the beacon sequence indicates a time offset between reception of the PSS and reception of one or more of the SSS or the PBCH. This aspect ensures the efficient use of the spectrum and reduced detection complexity by enabling the use of beacon signals to indicate SSS transmissions, PBCH transmissions, or both, or to indicate an instance or an offset to a next SSS transmission, a next PBCH transmission, or both.

Additionally, or alternatively, the UE 900 may be configured to support where the beacon sequence is separated from the PSS in the slot by a first quantity of guard subcarriers, the first quantity of guard subcarriers based on a second quantity of guard subcarriers between the SSS and the PBCH. This aspect ensures the efficient use of the spectrum and reduced detection complexity by enabling beacon sequences to indicate the presence of a PBCH. Additionally, or alternatively, the UE 900 may be configured to support detecting a first beacon signal indicating a first beacon sequence and a second beacon signal indicating a second beacon sequence in the slot. This aspect ensures the efficient use of the spectrum and reduced detection complexity by enabling beacon sequences to indicate the presence of a PBCH. Additionally, or alternatively, the UE 900 may be configured to support detecting the presence of one or more of the SSS or the PBCH in the slot based on the first beacon sequence and the second beacon sequence. This aspect ensures the efficient use of the spectrum and reduced detection complexity by enabling beacon sequences to indicate the presence of a PBCH.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

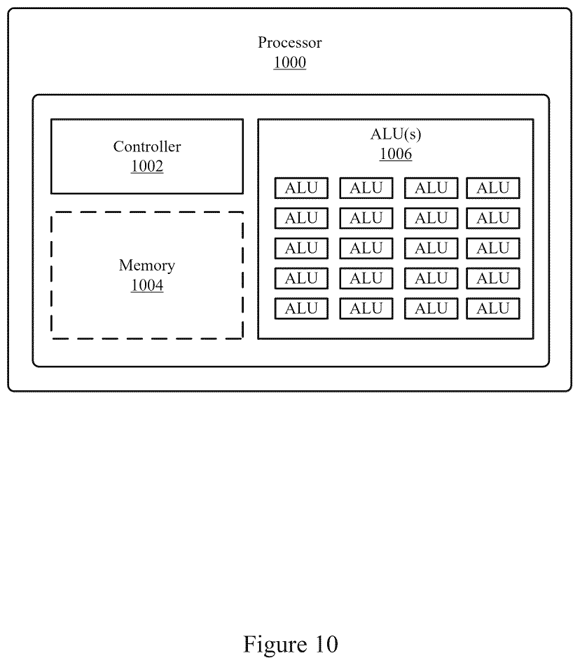

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to receive one or more sequences and one or more of a PSS or an SSS in a slot; and detect a presence of a PBCH in the slot based on detection of the one or more sequences in the slot. In this manner, the processor 1000 supports power and energy saving for various cell signals and channels by enabling the presence or non-presence of a PBCH to be indicated and detected by means of a PSS or a PSS and an SSS.

Additionally, the processor 1000 may be configured to or operable to support any one or combination of the following. For example, the processor 1000 may be configured to or operable to support detecting the one or more sequences in the slot, the one or more sequences including one or more of a sequence number for the PSS or a sequence number for the SSS. This aspect ensures power savings by enabling PSS and/or SSS sequences to indicate the presence of a PBCH. Additionally, or alternatively, the processor 1000 may be configured to or operable to support where one or more sequence numbers for the PSS or the SSS correspond to a respective offset, each offset indicated as a quantity of slots or a quantity of SSB/PBCH block occurrences. This aspect improves efficiency of PBCH indication and detection by defining an offset to a next PBCH transmission.

Additionally, or alternatively, the processor 1000 may be configured to or operable to support where one or more cell IDs corresponding to the one or more sequence numbers are unavailable for cell deployment based on the one or more sequence numbers indicating the presence of the PBCH in the slot. This aspect improves efficiency of PBCH indication and detection by defining a relationship between SSS IDs and the offset to the next PBCH transmission. Additionally, or alternatively, the processor 1000 may be configured to or operable to support where the sequence number for the SSS indicates a time offset between reception of one or more of the PSS or the SSS and reception of the PBCH. This aspect improves efficiency of PBCH indication and detection by defining a relationship between SSS IDs and the offset to the next PBCH transmission.

Additionally, or alternatively, the processor 1000 may be configured to or operable to support where the time offset indicates the PBCH is received in the slot, the PBCH is received immediately after the slot, or the PBCH is excluded from the slot. This aspect improves efficiency of PBCH indication and detection by defining an offset to a next PBCH transmission. Additionally, or alternatively, the processor 1000 may be configured to or operable to support determining the time offset based on a subset of bits used to indicate the sequence number for the SSS. This aspect improves efficiency of PBCH indication and detection by defining an offset to a next PBCH transmission.

Additionally, or alternatively, the processor 1000 may be configured to or operable to support detecting the one or more sequences in the slot, the one or more sequences including a beacon sequence that indicates the presence of one or more of the SSS or the PBCH in the slot. This aspect ensures power savings by enabling beacon sequences to indicate the presence of a PBCH. Additionally, or alternatively, the processor 1000 may be configured to or operable to support where the beacon sequence indicates a time offset between reception of the PSS and reception of one or more of the SSS or the PBCH. This aspect ensures the efficient use of the spectrum and reduced detection complexity by enabling the use of beacon signals to indicate SSS transmissions, PBCH transmissions, or both, or to indicate an offset to a next SSS transmission, a next PBCH transmission, or both.

Additionally, or alternatively, the processor 1000 may be configured to or operable to support where the beacon sequence is separated from the PSS in the slot by a first quantity of guard subcarriers, the first quantity of guard subcarriers based on a second quantity of guard subcarriers between the SSS and the PBCH. This aspect ensures the efficient use of the spectrum and reduced detection complexity by enabling beacon sequences to indicate the presence of a PBCH. Additionally, or alternatively, the processor 1000 may be configured to or operable to support detecting a first beacon signal indicating a first beacon sequence and a second beacon signal indicating a second beacon sequence in the slot. This aspect ensures the efficient use of the spectrum and reduced detection complexity by enabling beacon sequences to indicate the presence of a PBCH. Additionally, or alternatively, the processor 1000 may be configured to or operable to support detecting the presence of one or more of the SSS or the PBCH in the slot based on the first beacon sequence and the second beacon sequence. This aspect ensures the efficient use of the spectrum and reduced detection complexity by enabling beacon sequences to indicate the presence of a PBCH.

Additionally, or alternatively, the processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to transmit one or more sequences and one or more of a PSS or an SSS in a slot, where the one or more sequences indicate a presence of a PBCH in the slot; and transmit the PBCH in the slot based on the one or more sequences indicating the presence of the PBCH. In this manner, the processor 1000 supports power and energy saving for various cell signals and channels by enabling the presence or non-presence of a PBCH to be indicated and detected by means of a PSS or a PSS and an SSS.

Additionally, the processor 1000 may be configured to or operable to support any one or combination of the following. For example, the processor 1000 may be configured to or operable to support transmitting transmit the one or more sequences in the slot, the one or more sequences including one or more of a sequence number for the PSS or a sequence number for the SSS. This aspect ensures power savings by enabling PSS and/or SSS sequences to indicate the presence of a PBCH. Additionally, or alternatively, the processor 1000 may be configured to or operable to support where one or more sequence numbers for the PSS or the SSS correspond to a respective offset, each offset indicated as a quantity of slots or a quantity of SSB/PBCH block occurrences. This aspect improves efficiency of PBCH indication and detection by defining an offset to a next PBCH transmission. Additionally, or alternatively, the processor 1000 may be configured to or operable to support where one or more cell IDs corresponding to the one or more sequence numbers are unavailable for cell deployment based on the one or more sequence numbers indicating the presence of the PBCH in the slot. This aspect improves efficiency of PBCH indication and detection by defining a relationship between SSS IDs and the offset to the next PBCH transmission.

Additionally, or alternatively, the processor 1000 may be configured to or operable to support where the sequence number for the SSS indicates a time offset between transmission of one or more of the PSS or the SSS and transmission of the PBCH. This aspect improves efficiency of PBCH indication and detection by defining a relationship between SSS IDs and the offset to the next PBCH transmission. Additionally, or alternatively, the processor 1000 may be configured to or operable to support transmitting the one or more sequences in the slot, the one or more sequences including a beacon sequence that indicates the presence of one or more of the SSS or the PBCH in the slot. This aspect ensures power savings by enabling beacon sequences to indicate the presence of a PBCH.

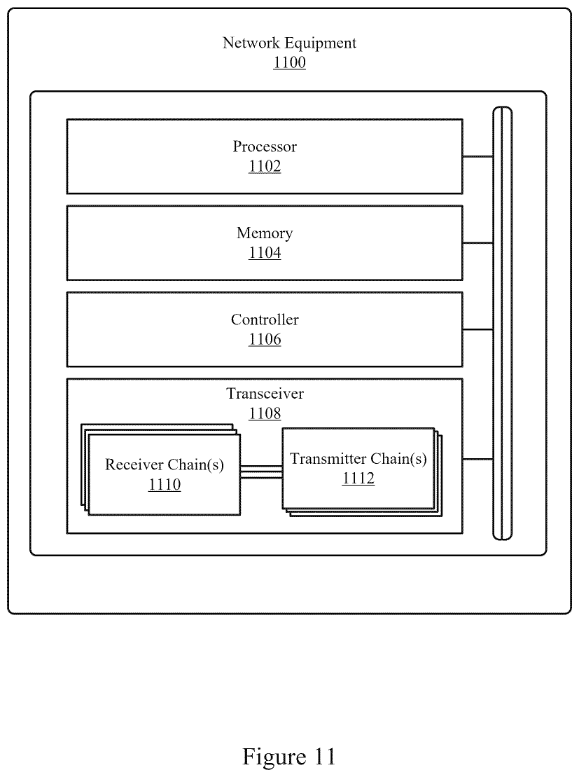

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for transmitting one or more sequences and one or more of a PSS or an SSS in a slot, where the one or more sequences indicate a presence of a PBCH in the slot; and transmitting the PBCH in the slot based on the one or more sequences indicating the presence of the PBCH. In this manner, the NE 1100 supports power and energy saving for various cell signals and channels by enabling the presence or non-presence of a PBCH to be indicated and detected by means of a PSS or a PSS and an SSS.

Additionally, the NE 1100 may be configured to support any one or combination of the following. For example, the NE 1100 may be configured to support transmitting the one or more sequences in the slot, the one or more sequences including one or more of a sequence number for the PSS or a sequence number for the SSS. This aspect ensures power savings by enabling PSS and/or SSS sequences to indicate the presence of a PBCH. Additionally, or alternatively, the NE 1100 may be configured to support where one or more sequence numbers for the PSS or the SSS correspond to a respective offset, each offset indicated as a quantity of slots or a quantity of SSB/PBCH block occurrences. This aspect improves efficiency of PBCH indication and detection by defining an offset to a next PBCH transmission. Additionally, or alternatively, the NE 1100 may be configured to support where one or more cell IDs corresponding to the one or more sequence numbers are unavailable for cell deployment based on the one or more sequence numbers indicating the presence of the PBCH in the slot. This aspect improves efficiency of PBCH indication and detection by defining a relationship between SSS IDs and the offset to the next PBCH transmission.

Additionally, or alternatively, the NE 1100 may be configured to support where the sequence number for the SSS indicates a time offset between transmission of one or more of the PSS or the SSS and transmission of the PBCH. This aspect improves efficiency of PBCH indication and detection by defining a relationship between SSS IDs and the offset to the next PBCH transmission. Additionally, or alternatively, the NE 1100 may be configured to support transmitting the one or more sequences in the slot, the one or more sequences including a beacon sequence that indicates the presence of one or more of the SSS or the PBCH in the slot. This aspect ensures power savings by enabling beacon sequences to indicate the presence of a PBCH.

Additionally, or alternatively, the NE 1100 may support at least one memory and at least one processor coupled with the at least one memory and configured to cause the NE 1100 to transmit one or more sequences and one or more of a PSS or an SSS in a slot, where the one or more sequences indicate a presence of a PBCH in the slot; and transmit the PBCH in the slot based on the one or more sequences indicating the presence of the PBCH. In this manner, the NE 1100 supports power and energy saving for various cell signals and channels by enabling the presence or non-presence of a PBCH to be indicated and detected by means of a PSS or a PSS and an SSS.

Additionally, the NE 1100 may be configured to support any one or combination of the following. For example, the NE 1100 may be configured to support transmitting the one or more sequences in the slot, the one or more sequences including one or more of a sequence number for the PSS or a sequence number for the SSS. This aspect ensures power savings by enabling PSS and/or SSS sequences to indicate the presence of a PBCH. Additionally, or alternatively, the NE 1100 may be configured to support where one or more sequence numbers for the PSS or the SSS correspond to a respective offset, each offset indicated as a quantity of slots or a quantity of SSB/PBCH block occurrences. This aspect improves efficiency of PBCH indication and detection by defining an offset to a next PBCH transmission. Additionally, or alternatively, the NE 1100 may be configured to support where one or more cell IDs corresponding to the one or more sequence numbers are unavailable for cell deployment based on the one or more sequence numbers indicating the presence of the PBCH in the slot. This aspect improves efficiency of PBCH indication and detection by defining a relationship between SSS IDs and the offset to the next PBCH transmission.

Additionally, or alternatively, the NE 1100 may be configured to support where the sequence number for the SSS indicates a time offset between transmission of one or more of the PSS or the SSS and transmission of the PBCH. This aspect improves efficiency of PBCH indication and detection by defining a relationship between SSS IDs and the offset to the next PBCH transmission. Additionally, or alternatively, the NE 1100 may be configured to support transmitting the one or more sequences in the slot, the one or more sequences including a beacon sequence that indicates the presence of one or more of the SSS or the PBCH in the slot. This aspect ensures power savings by enabling beacon sequences to indicate the presence of a PBCH.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

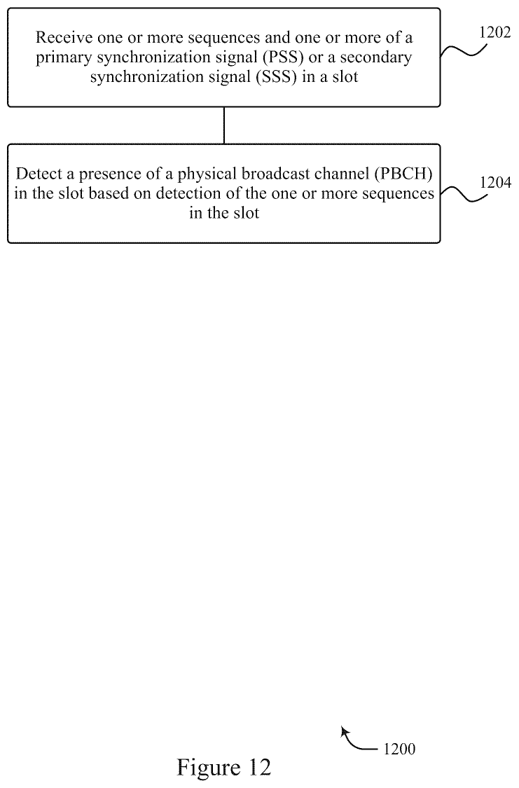

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1202, the method may include receiving one or more sequences and one or more of a PSS or an SSS in a slot. The operations of 1202 may be performed in accordance with examples as described herein. In some implementations, aspects of the operations of 1202 may be performed by a device such as a UE as described with reference to FIG. 9.

At 1204, the method may include detecting a presence of a PBCH in the slot based on detection of the one or more sequences in the slot. The operations of 1204 may be performed in accordance with examples as described herein. In some implementations, aspects of the operations of 1204 may be performed by a device such as a UE as described with reference to FIG. 9.

It should be noted that the method described herein describes a possible implementation, and that the operations and the steps may be rearranged or otherwise modified and that other implementations are possible.

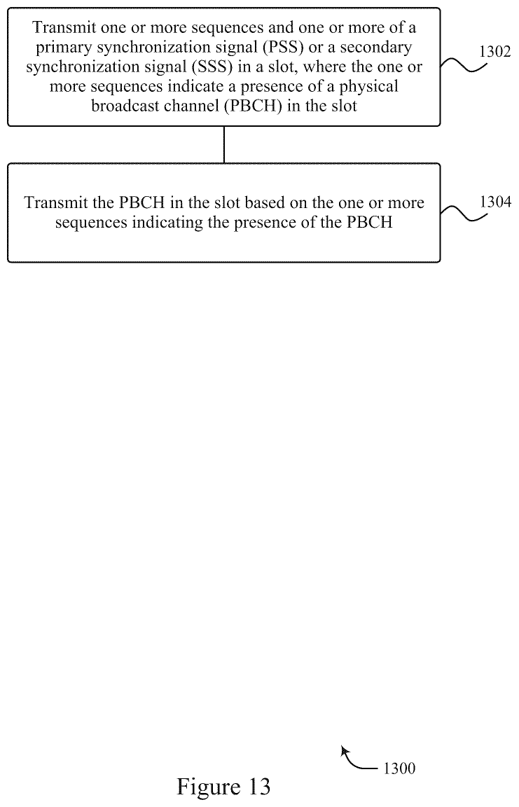

FIG. 13 illustrates a flowchart of a method 1300 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include transmitting one or more sequences and one or more of a PSS or an SSS in a slot, where the one or more sequences indicate a presence of a PBCH in the slot. The operations of 1302 may be performed in accordance with examples as described herein. In some implementations, aspects of the operations of 1302 may be performed by a device such as an NE as described with reference to FIG. 11.

At 1304, the method may include transmitting the PBCH in the slot based on the one or more sequences indicating the presence of the PBCH. The operations of 1304 may be performed in accordance with examples as described herein. In some implementations, aspects of the operations of 1304 may be performed by a device such as an NE as described with reference to FIG. 11.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive one or more sequences and one or more of a primary synchronization signal (PSS) or a secondary synchronization signal (SSS) in a slot; and
detect a presence of a physical broadcast channel (PBCH) in the slot based at least in part on detection of the one or more sequences in the slot.

2. The UE of claim 1, wherein the at least one processor is further operable to cause the UE to detect the one or more sequences in the slot, the one or more sequences including one or more of a sequence number for the PSS or a sequence number for the SSS.

3. The UE of claim 2, wherein one or more sequence numbers for the PSS or the SSS correspond to a respective offset, each offset indicated as a quantity of slots or a quantity of synchronization signal block (SSB)/PBCH block occurrences.

4. The UE of claim 3, wherein one or more cell identifiers (IDs) corresponding to the one or more sequence numbers are unavailable for cell deployment based at least in part on the one or more sequence numbers indicating the presence of the PBCH in the slot.

5. The UE of claim 2, wherein the sequence number for the SSS indicates a time offset between reception of one or more of the PSS or the SSS and reception of the PBCH.

6. The UE of claim 5, wherein the time offset indicates the PBCH is received in the slot, the PBCH is received immediately after the slot, or the PBCH is excluded from the slot.

7. The UE of claim 5, wherein the at least one processor is further operable to cause the UE to determine the time offset based at least in part on a subset of bits used to indicate the sequence number for the SSS.

8. The UE of claim 1, wherein the at least one processor is further operable to cause the UE to detect the one or more sequences in the slot, the one or more sequences including a beacon sequence that indicates the presence of one or more of the SSS or the PBCH in the slot.

9. The UE of claim 8, wherein the beacon sequence indicates a time offset between reception of the PSS and reception of one or more of the SSS or the PBCH.

10. The UE of claim 8, wherein the beacon sequence is separated from the PSS in the slot by a first quantity of guard subcarriers, the first quantity of guard subcarriers based at least in part on a second quantity of guard subcarriers between the SSS and the PBCH.

11. The UE of claim 1, wherein the at least one processor is further operable to cause the UE to detect a first beacon signal indicating a first beacon sequence and a second beacon signal indicating a second beacon sequence in the slot.

12. The UE of claim 11, wherein the at least one processor is further operable to cause the UE to detect the presence of one or more of the SSS or the PBCH in the slot based at least in part on the first beacon sequence and the second beacon sequence.

13. A network equipment (NE) for wireless communication, comprising:
at least one memory; and
at least one processor coupled with the at least one memory and operable to cause the NE to:
transmit one or more sequences and one or more of a primary synchronization signal (PSS) or a secondary synchronization signal (SSS) in a slot, wherein the one or more sequences indicate a presence of a physical broadcast channel (PBCH) in the slot; and
transmit the PBCH in the slot based at least in part on the one or more sequences indicating the presence of the PBCH.

14. The NE of claim 13, wherein the at least one processor is further operable to cause the NE to transmit the one or more sequences in the slot, the one or more sequences including one or more of a sequence number for the PSS or a sequence number for the SSS.

15. The NE of claim 14, wherein one or more sequence numbers for the PSS or the SSS correspond to a respective offset, each offset indicated as a quantity of slots or a quantity of synchronization signal block (SSB)/PBCH block occurrences.

16. The NE of claim 15, wherein one or more cell identifiers (IDs) corresponding to the one or more sequence numbers are unavailable for cell deployment based at least in part on the one or more sequence numbers indicating the presence of the PBCH in the slot.

17. The NE of claim 14, wherein the sequence number for the SSS indicates a time offset between transmission of one or more of the PSS or the SSS and transmission of the PBCH.

18. The NE of claim 13, wherein the at least one processor is further operable to cause the NE to transmit the one or more sequences in the slot, the one or more sequences including a beacon sequence that indicates the presence of one or more of the SSS or the PBCH in the slot.

19. A method performed by a user equipment (UE), the method comprising:
receiving one or more sequences and one or more of a primary synchronization signal (PSS) or a secondary synchronization signal (SSS) in a slot; and
detecting a presence of a physical broadcast channel (PBCH) in the slot based at least in part on detection of the one or more sequences in the slot.

20. A method performed by a network equipment (NE), the method comprising:
transmitting one or more sequences and one or more of a primary synchronization signal (PSS) or a secondary synchronization signal (SSS) in a slot, wherein the one or more sequences indicate a presence of a physical broadcast channel (PBCH) in the slot; and
transmitting the PBCH in the slot based at least in part on the one or more sequences indicating the presence of the PBCH.
